(19) United States
(12) Patent Application Publication
(10) Pub. No.: US 2004/0015385 A1
(43) Pub. Date: Jan. 22, 2004

(54) Delivery reception aknowledging method and delivery reception acknowledging system

(76) Inventor: Takayasu Kumakawa, Kyoto (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/344,897

(22) PCT Filed: Aug. 31, 2001
(86) PCT No.: PCT/JP01/07551

(30) Foreign Application Priority Data
Aug. 31, 2000 (JP) P2000-263104

(51) Int. Cl. G06F 17/60

(52) U.S. Cl. 705/9; 705/10

(57) ABSTRACT

A trace (53) reads an arrival sheet for which the reception is acknowledged, creates an image of a reception acknowledgement, and stores the image of the reception acknowledgement in an image file after relating the image to an inquiry number. When a terminal such as a PC (11) or a portable telephone (12) is provided to the receiver requests for a reception acknowledgement through the entry of the inquiry number or the facsimile number, a CPU (56) retrieves the image of the reception acknowledgement corresponding to the inquiry number from the terminal from the image file. A facsimile transmission unit (60) transmits the retrieved image of the reception acknowledgement and the inquiry number. A facsimile device (13) installed on the receiver side receives the image of the reception acknowledgement and the inquiry number from the facsimile transmission unit (60) through a public line (3).

### TECHNICAL FIELD

The present invention relates to a delivery reception acknowledging method and a delivery reception acknowledging system for receiving a reception acknowledgement on an arrival sheet in the form of a reception stamp or the like when a parcel sent from a sender is delivered to receiver, and more particularly to a delivery reception acknowledging method and a delivery reception acknowledging system in which an image of the reception acknowledgement is transmitted to a specified transmission destination complying with the sender's request for the reception acknowledgement.

### BACKGROUND ART

When a parcel is sent from a sender to a receiver, generally, the parcel delivery is entrusted to an express company. In this case, the sender writes specified matters into an invoice presented by the express company. This invoice is composed of plural sheets to be printed by copy, namely, a copy for sender, a charge request sheet, a parcel tag, an arrival sheet and a copy for receiver. Each sheet has a column for entries of a sender's name, address, and telephone number, a column for entries of a receiver's name, address, and telephone number, a column for entry of an inquiry number indicating a slip number of the invoice, a bar code indicating the inquiry number, a column for entry of an arrival shop name or code for distributing the parcel and the like.

The parcel tag in which specified matters are written is attached to a parcel and a reception stamp is marked on the copy for sender by a parcel collector, thereby establishing a business trust contract between the sender and the express company.

The parcel collector carries the parcel and the invoice to a parcel collecting shop of the express company. Furthermore, after the parcel is sent from the parcel collecting shop to a relay center, the parcel is sent from the relay center to a receiver's nearest distribution shop (arrival shop) on the basis of the arrival shop name written on the parcel tag. A delivery person of the distribution shop delivers the parcel to the receiver, and then the receiver receives the parcel from the delivery person.

At this time, the delivery person obtains a reception stamp (that is, reception acknowledgement) from the receiver in a column for entry of a reception stamp on the arrival sheet and carries back the arrival sheet marked with the reception stamp to the distribution shop. This arrival sheet is stored and this parcel delivery is completed.

If the sender customer requests confirmation of the reception acknowledgement made by marking the reception stamp, the express company copies the arrival sheet and then sends the copied arrival sheet to the sender customer by mail.

However, since the arrival sheet marked with the reception stamp exists for each parcel, the express company must store a large number of the arrival sheets each marked with reception stamp. Therefore, the express company takes a quite long time to find the arrival sheet, which corresponds to reception acknowledgement to be confirmed by the sender customer, from such a large number of the arrival sheets.

Further, since the express company stores a large number of the arrival sheets, it takes a quite large space and quite high cost to manage the storage space. Moreover, since the express company sends the copied arrival sheet to the customer by mail, it takes one to three days for the arrival sheet to arrive at the customer after it has been sent by the express company.

### DISCLOSURE OF INVENTION

An object of the present invention is to provide a delivery reception acknowledging method and a delivery reception acknowledging system which enables sender customer to confirm a reception acknowledgement by a receiver in a short time by presenting an image of the reception acknowledgement if the customer requests confirmation of the reception acknowledgement and which enables the cost of storage space for the arrival sheets to be reduced.

To solve the above-described problem, the present invention provides a following structure. More specifically, the present invention provides a delivery reception acknowledging system for receiving a receiver's reception acknowledgement on a slip containing sender information and receiver information when a parcel sent from a sender is delivered to a receiver, the system comprising a reading means for reading the slip on which the reception acknowledgement is marked so as to obtain an image of the reception acknowledgement, a terminal for requesting the reception acknowledgement, the terminal provided on the side of the sender and connected to a communication network, a transmitting means for transmitting the image of the reception acknowledgement obtained by the reading means complying with a request for the reception acknowledgement from the terminal, the transmitting means connected to the communication network, and a receiving means for receiving the image of the reception acknowledgement from the transmitting means through the communication network, the receiving means provided on the side of the sender.

According to the present invention, if the reading means obtains an image of the reception acknowledgement by reading a slip on which the reception acknowledgement is marked and then the terminal provided on the side of a sender requests the reception acknowledgement, the transmitting means transmits the image of the reception acknowledgement obtained by the reading means complying with a request for the reception acknowledgement from the terminal. Then, the receiving means provided on the side of a sender receives the image of the reception acknowledgement from the transmitting means through communication network. Consequently, customer can confirm the reception acknowledgement by the receiver with its security in a short time and additionally, the cost of storage space for a slip such as the arrival sheets can be reduced.

Further, the present invention provides a delivery reception acknowledging system for receiving a receiver's reception acknowledgement on a slip containing sender information and receiver information when a parcel sent from a sender is delivered to a receiver, the system comprising a reading means for reading the slip on which the reception acknowledgement is marked so as to obtain an image of the reception acknowledgement, a terminal for requesting the reception acknowledgement, the terminal provided on the side of the sender and connected to communication network, a transmitting means for transmitting the image of the reception acknowledgement obtained by the reading means complying with a request for the reception acknowledgement from the terminal, and a server for presenting the image of the reception acknowledgement from the transmitting means to the terminal, the server connected to the communication network.

According to the present invention, if the reading means obtains an image of the reception acknowledgement by reading a slip on which the reception acknowledgement is marked and then the terminal provided on the side of a sender requests the reception acknowledgement, the transmitting means transmits the image of the reception acknowledgement obtained by the reading means complying with a request for the reception acknowledgement from the terminal. Then, the server connected to communication network presents the image of the reception acknowledgement from the transmitting means to the terminal. Consequently, customer can confirm the reception acknowledgement by the receiver in a short time and the cost of storage space for a slip such as the arrival sheet can be reduced.

### BRIEF DESCRIPTION OF DRAWINGS

FIG. 1 is a schematic structure block diagram of a delivery reception acknowledging system according to a first embodiment of the present invention;

FIG. 2 is a specific configuration diagram of the delivery reception acknowledging system according to the first embodiment;

FIG. 3 is a diagram showing the detail of an invoice being composed of plural copy sheets;

FIG. 4 is a diagram showing the detail of an arrival sheet including a marked reception stamp;

FIG. 5 is a diagram showing an image file;

FIG. 6 is a diagram showing a request file for reception stamp and an acknowledgement file for reception stamp;

FIG. 7 is a diagram for explaining process for reading an image of the reception stamp;

FIG. 8 is a flow chart showing process for acknowledging reception stamp in a host computer and a local computer center;

FIG. 9 is a sequence diagram showing process procedure in the delivery reception acknowledging system according to the first embodiment;

FIG. 10 is a diagram showing the detail of a request window for reception stamp;

FIG. 11 is a diagram showing an acknowledgement data for reception stamp outputted form a fax device;

FIG. 12 is a schematic structure block diagram of a delivery reception acknowledging system according to a second embodiment of the present invention; and

FIG. 13 is a sequence diagram showing process procedure in the delivery reception acknowledging system according to the second embodiment.

### BEST MODE FOR CARRYING OUT THE INVENTION

Hereinafter, the embodiments of the delivery reception acknowledging method and the delivery reception acknowledging system in the present invention will be described in detail with reference to the drawings.

(First Embodiment)

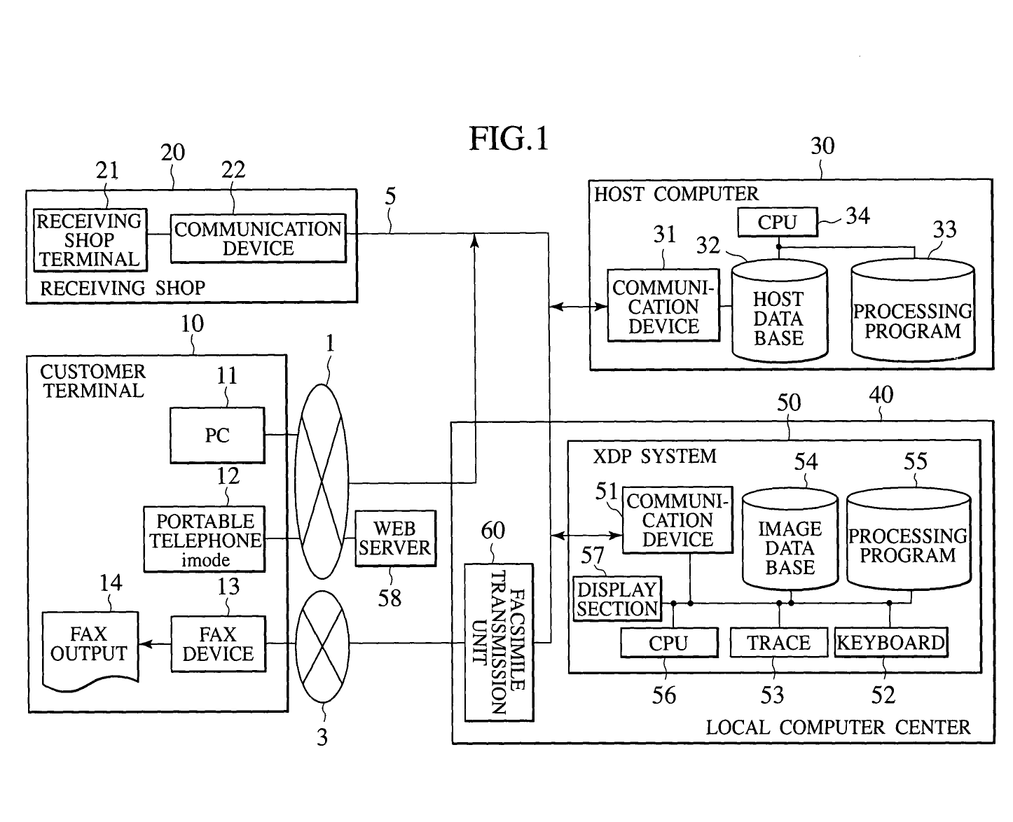

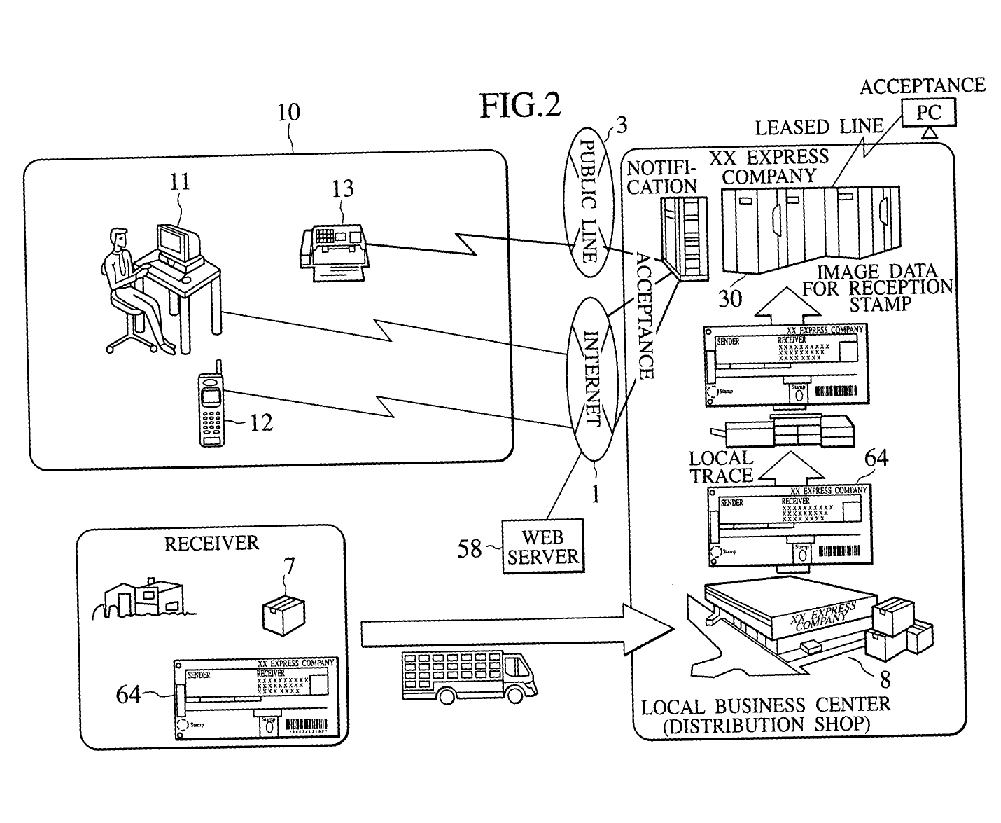

FIG. 1 is a schematic structure block diagram of the delivery reception acknowledging system according to the first embodiment of the present invention. FIG. 2 is a specific configuration diagram of the delivery reception acknowledging system according to the first embodiment.

The feature of the delivery reception acknowledging system according to the first embodiment is that sender is allowed to confirm a reception acknowledgement by receiver in a short time with its security by presenting an image of the reception acknowledgement when a sender (customer) requests confirmation of the reception acknowledgement, and is also that the cost of storage space for an arrival sheet can be reduced.

In the first embodiment, a reception stamp marked in a column for entry of reception stamp on an arrival sheet serves as a reception acknowledgement by the receiver. Instead of a reception stamp, receiver's signature (sign) written into the column on the arrival sheet may be regarded as the reception acknowledgement.

The delivery reception acknowledging system shown in FIG. 1 is composed of customer terminals 10, receiving shops 20 connected to a leased line 5 (corresponding to communication network in the present invention) and located on customer side, a host computer 30 installed in such an express company as XX Kyubin, and local computer centers 40 located in such an express company as XX Kyubin. The local computer centers 40 are located at, for example 10 local areas in Japan.

The customer terminal 10 has a personal computer 11 (hereinafter referred to as PC) connected to Internet 1 (corresponding to communication network in the present invention), a portable telephone 12 connected to Internet 1 and supporting browser, fax device 13 (corresponding to a receiving means in the present invention) connected to public telephone line 3 (corresponding to communication network in the present invention), and a printer 14.

The PC 11 and the portable telephone 12 are connected to web server 58 through Internet 1 and each of them contains World Wide Web browser section (hereinafter referred to as WWW browser section). According to URL (Uniform Resource Locator) inputted by customer, the WWW browser section requests the web server 58 with that URL to transmit information. Thereby, the WWW browser section carries out process for analyzing and displaying the information transmitted from the web server 58 and process for sending information inputted by custom to the web server 58. The Internet 1 is an open line network operated according to a world-wide common protocol.

The web server 58 provides customer with request window for reception stamp (corresponding to request window for a reception acknowledgement in the present invention) through the Internet 1, wherein the request window urging an entry of each item in response to the customer's request for the reception stamp. Further, the web server 58 stores request data for reception stamp entered by the customer and periodically transmits the data to the host computer 30.

The PC 11 or the portable telephone 12 fills in each item of the request window, complying with orders on the request window provided by the web server 58. Thereafter, the request data are transmitted to the web server 58 through the Internet 1.

The respective items are an inquiry number indicating a slip number of a copy for customer included in an invoice, a customer telephone number, a customer name, a destination name, a destination fax number and the like. The inquiry number also indicates a slip number of an arrival sheet (corresponding to a slip in the present invention).

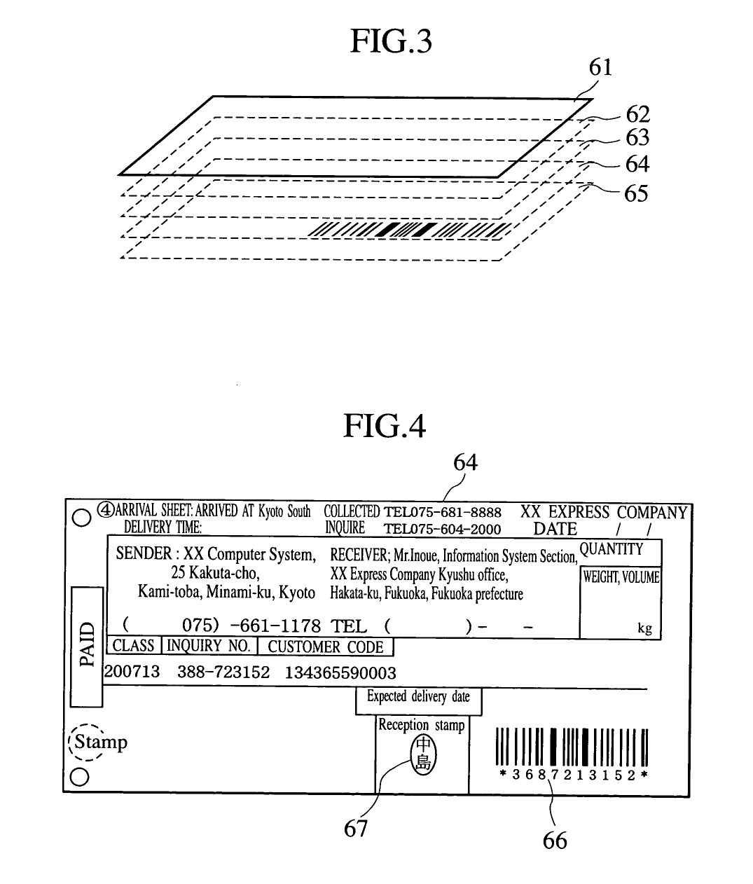

As shown in FIG. 3, the invoice is composed of plural sheets which are to be printed by copy, for example a copy for customer 61, a charge request sheet 62, a parcel tag 63, an arrival sheet 64, and an invoice copy 65 while the same inquiry number is printed on the copy for customer 61 and the arrival sheet 64.

On the arrival sheet 64, as shown in FIG. 4, a sender's name, address and telephone number are entered in a sender column and a receiver's name, address and telephone number are entered in a receiver column. An inquiry number indicating a slip number of an invoice is entered in an inquiry number column, a bar code 66 indicating the inquiry number and an arrival shop name or code is entered on the arrival sheet 64. Further, a receiver's reception stamp 67 acknowledging that parcel is received is marked in a reception stamp column on the arrival sheet 64.

The receiving shop 20 has a receiving shop terminal 21 for inputting the request data for a reception acknowledgement such as an inquiry number, a customer telephone number, a customer name, a destination name, a destination fax number and the like, and has a communication device 22 for transmitting the request data inputted from the receiving shop terminal 21 to the host computer 30 through the leased line 5.

The host computer 30 is connected to the Internet 1, the leased line 5 and the local computer center 40. The host computer 30 has a communication device 31 (corresponding to a transmitting means in the present invention) for transmitting or receiving data, a host data base 32, a processing program 33 for coping with custom's request for the reception stamp and a central processing unit (hereinafter referred to as CPU) for executing this processing program.

The CPU 34 stores in the host data base 32 the request data transmitted from the web server 58 or the receiving shop 20 through the communication device 31. The host data base 32, as shown in FIG. 6(a), contains a request file 73 for reception stamp in which the request data such as an inquiry number, a customer telephone number, a customer name, a destination name, a destination fax number are written, corresponding to the inquiry number.

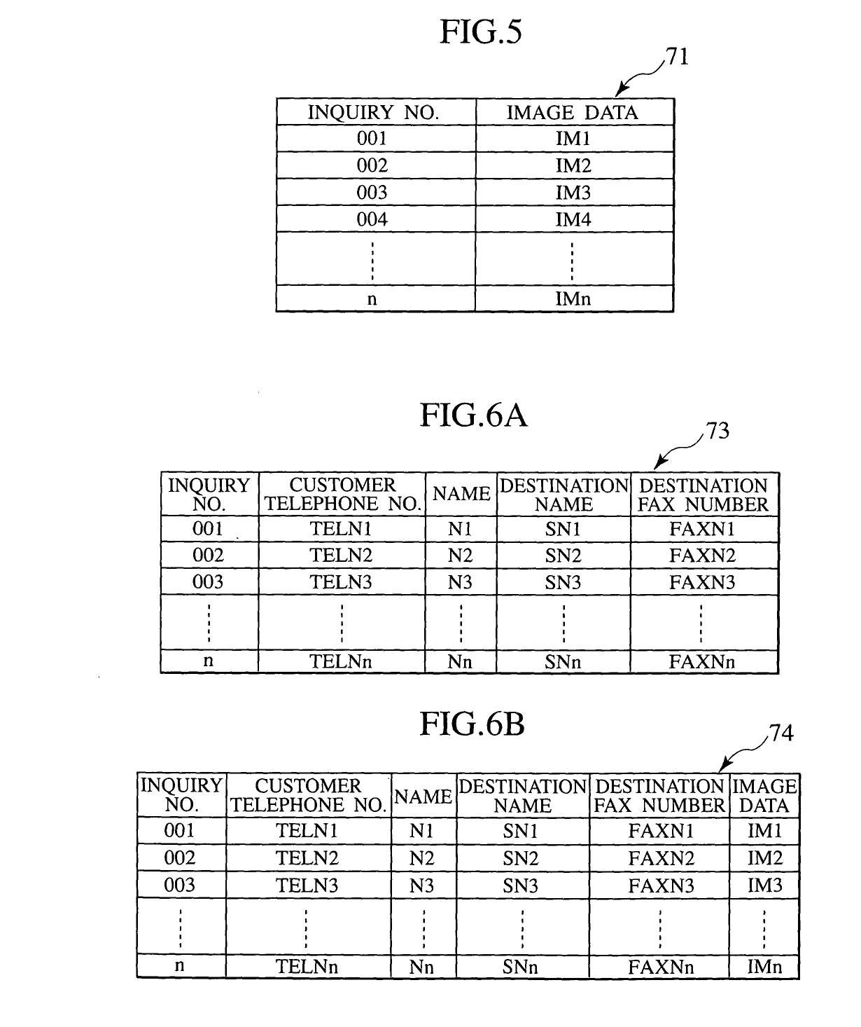

The local computer center 40 has an XDP system 50 serving as an image retrieval system and a facsimile transmission unit 60 (corresponding to transmission means in the present invention). The XDP system 50 includes a communication device 51 for transmitting or receiving data, a keyboard 52 for inputting various kinds of information, a trace 53 (corresponding to reading means in the present invention) for reading the arrival sheet 64 to acknowledge a reception so as to obtain an image of the reception acknowledgement (hereinafter referred to as image data), an image data base 54 containing an image file 71 in which the image data obtained by the trace 53 is stored in correspondence with the inquiry number, a processing program 55 for coping with custom's request for the reception stamp, a CPU 56 for executing this processing program 55 and a display section 57 for displaying information. The image file 71, as shown in FIG. 5, contains the inquiry number (for example, 001) and the image data (for example, IM1) under their relations of one-to-one correspondence. Instead of the trace 53, as the reading means, it is permissible to use a reading device, a scanner, “IL500/Kodak product” or the like.

The CPU 56 retrieves the image data corresponding to the inquiry number transmitted from the PC 11, the portable telephone 12 or the receiving shop 20 with reference to the image file 71 and the request file 73. Thereafter, the CPU 56 combines the retrieved image data and the request data so as to create an acknowledgement file 74 for reception stamp shown in FIG. 6(b) and then transmits it to the host computer 30.

The communication device 31 transmits acknowledgement data for reception stamp in the acknowledgement file 74 to the facsimile transmission unit 60. The facsimile transmission unit 60 transmits the acknowledgement data to the fax device 13 through the public telephone line 3, wherein the fax device 13 corresponds to a transmission destination indicated by a transmission destination number. The fax device 13 receives the acknowledgement data from the facsimile transmission unit 60 through the public telephone line 3.

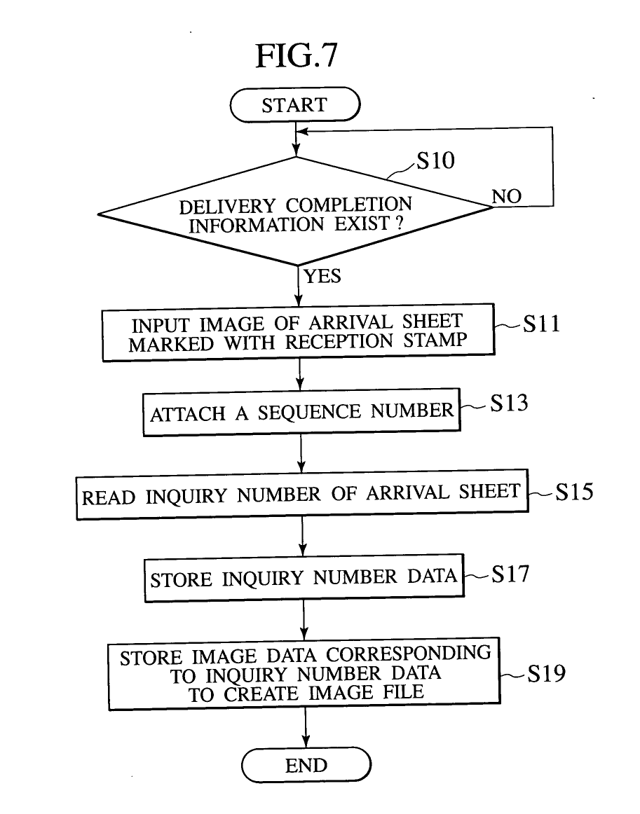

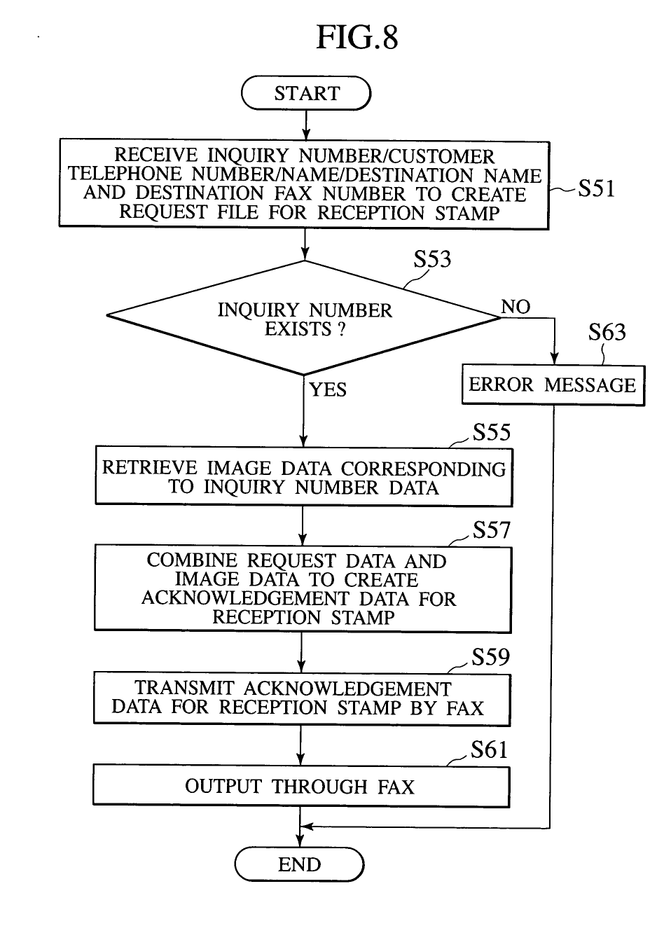

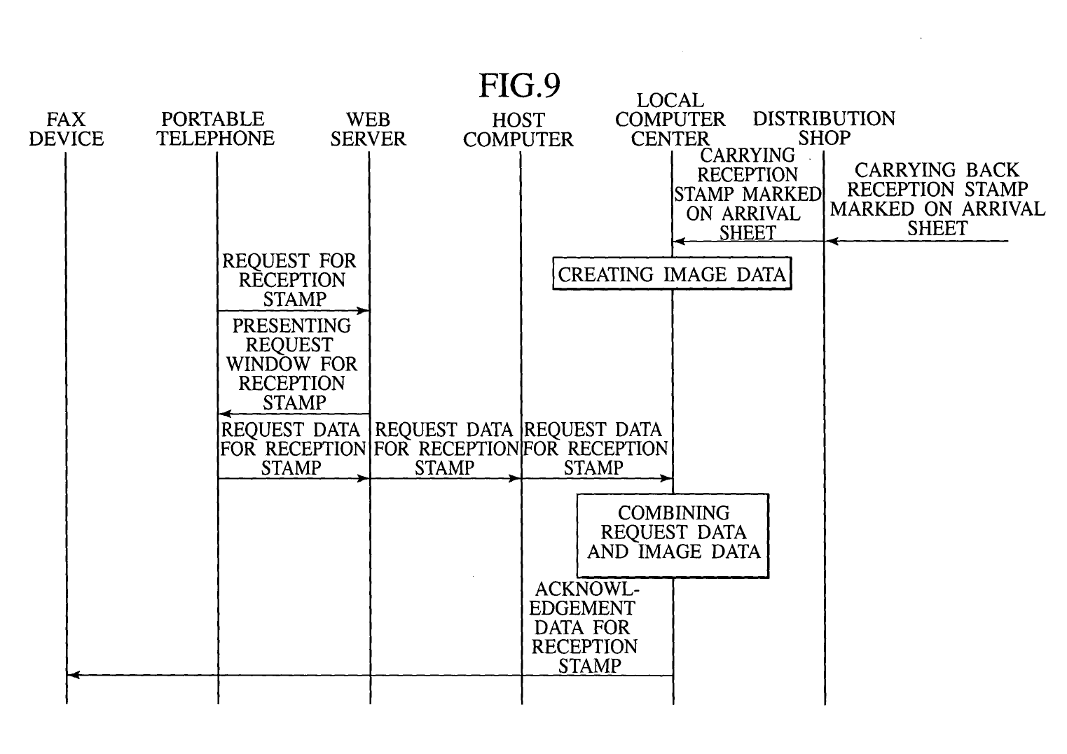

Next, the delivery reception acknowledging method will be described with reference to flow charts shown in FIGS. 7 and 8 and a sequence diagram shown in FIG. 9, wherein the method is realized by the delivery reception acknowledging system of the embodiment having above-described structure.

First, the process for reading an image of the reception acknowledgement will be described with reference to the flow chart shown in FIG. 7. As shown in FIG. 2, a delivery person of a distribution shop 8 delivers a parcel to a receiver and receives a reception stamp from the receiver in the reception stamp column on the arrival sheet. When the parcel delivery is completed, the delivery person operates PDT (portable data terminal: portable terminal) and then transmits delivery completion information (corresponding to delivery completion PDT) to the local computer center 40, wherein the delivery completion information indicating that the parcel delivery is completed. Thereafter, the delivery person carries back the arrival sheet 64 marked with the reception stamp to the distribution shop 8 and then this arrival sheet 64 is carried to the local computer center 40.

Next, in the local computer center 40, it is determined whether or not there is any delivery completion information (step S10). If there is any delivery completion information, it is determined that the parcel delivery is completed.

Further, an image of the arrival sheet 64 marked with the reception stamp is captured by the trace 53 (step S11) and then a sequence number is attached (step S13). The inquiry number of the arrival sheet 64 is read (step S15) and then the read inquiry number is stored (step S17). Finally, the image data is stored corresponding to the inquiry number so as to create an image file 71 (step S19).

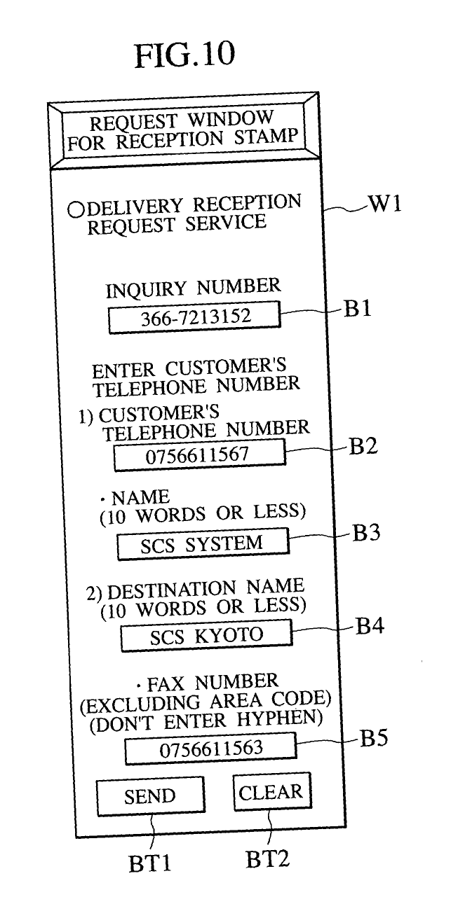

Next, a customer operates, for example, i-mode menu of the portable telephone 12 supporting browser, and inputs URL of an express company in order to select request service for reception stamp in delivery. After these operations, the web server 58 provides a request window for reception stamp to the portable telephone 12 in response to that URL and consequently, the request window WI is displayed on the screen of the portable telephone 12 as shown in FIG. 10.

The customer enters an inquiry number into an input frame B1, a customer telephone number into an input frame B2, a name into an input frame B3, a destination name into an input frame B4 and a fax number into an input frame B5. Then, if there is no mistake in entered content, a sending button BT1 is clicked. If there is a correction, a clear button BT2 is clicked and then reentry is carried out.

As the inquiry number to be entered into the input frame B1, an inquiry number written in the copy for customer 61 is entered, wherein the copy for customer 61 being the copy of the invoice received by the sender is entered.

The request data inputted to the request window W1 is stored in the web server 58 through the Internet 1. The host computer 30 accesses the web server 58 periodically and receives the request data from the web server 58 so as to create a request file 73 in the host data base 32 (step S51).

Next, in the XDP system 50, the CPU 56 determines whether or not there is the same inquiry number as the inquiry number from the portable telephone 12 with reference to the image file 71 (step S53). If the same inquiry number exists, an image data corresponding to that inquiry number is retrieved (step S55).

Further, the CPU 56 combines the retrieved image data and the request data from the portable telephone 12 so as to create the acknowledgement file 74 for reception stamp, wherein the acknowledgement file 74 is composed of the acknowledgement data for reception stamp (step S57). After that file is transmitted to the host computer 30, the communication device 31 transmits the acknowledgement data in the acknowledgement file 74 to the facsimile transmission unit 60. The facsimile transmission unit 60 transmits the acknowledgement data to the fax device 13 through the public telephone line 3 (step S59).

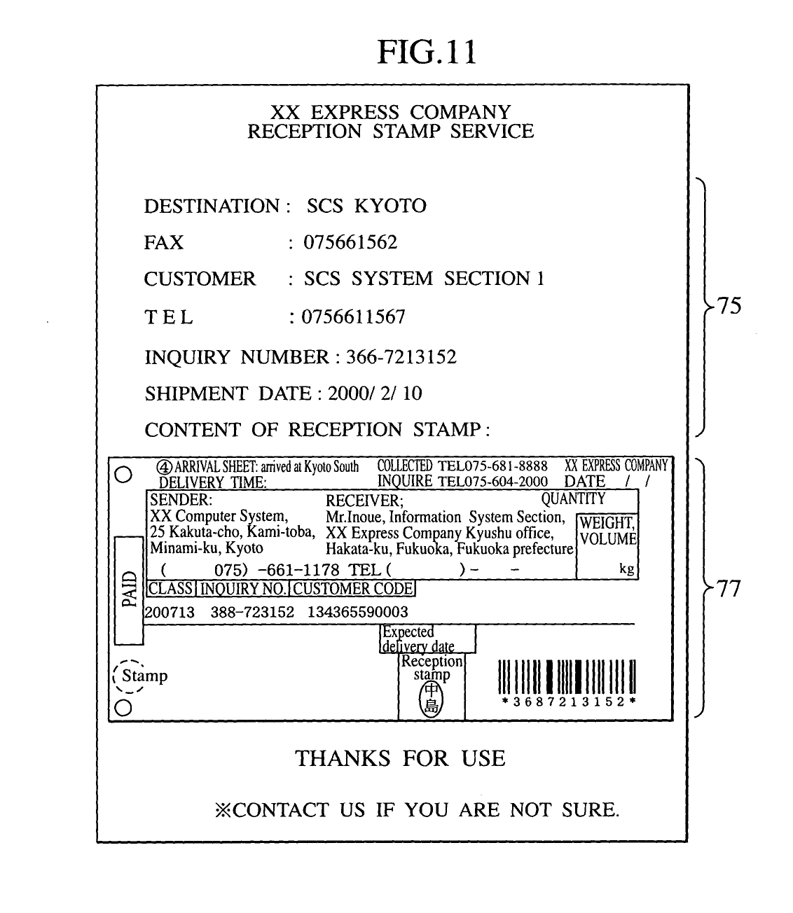

The fax device 13 receives the acknowledgement data from the facsimile transmission unit 60 through the public telephone line 3 and then outputs to the printer 14 (step S61). Consequently, as shown in FIG. 11, the acknowledgement data is printed, wherein the acknowledgement data having the request data 75 and the image data 77 of the arrival sheet 64 containing the marked reception stamp. The request data 75 is constituted of destination name (corresponding to a destination), fax number (corresponding to fax), name (corresponding to a request person) and inquiry number, each of them entered to the request window.

If in step S53, there is no same inquiry number as the inquiry number from the portable telephone 12 in the image file 71, error message indicating that the inquiry number is wrong is transmitted (step S63).

In the meantime, before the parcel delivery is completed, the request for reception stamp may be sometimes sent from the portable telephone 12. In such a case, there is no same inquiry number in the image table 71 as the inquiry number from the portable telephone 12.

In that case, it is permissible to send to a sender a mail written “The parcel delivery corresponding to your request number is not yet completed. The acknowledgement data for reception stamp will be sent to as soon as the parcel delivery is completed”. Thereafter, if the parcel delivery is completed and then an inquiry number and image data corresponding to the parcel are stored in the image table 71, it is permissible to retrieve image data corresponding to that inquiry number and send it to the sender.

It is permissible to use the PC 11 instead of the portable telephone 12. In the PC 11, the request for reception stamp is carried out through home page of a XX express company according to its request window for reception stamp and then the request data for reception stamp is stored in the server 58. Further, the request data is transmitted to the host computer 30. Process after these operations is the same as the above-described process in the portable telephone 12.

If the request for reception stamp is carried out through the receiving shop 20, the request data is sent to the host computer 30 through the leased line 5 and the process after these operations is the same as the above-described process in the portable telephone 12.

According to the delivery reception acknowledging method and the system of the first embodiment, the trace 53 reads the arrival sheet 64 acknowledging the reception so as to obtain the image data. When the portable telephone 12, the PC 11 or the terminal of the receiving shop 20 and the like requests reception acknowledgement including the inquiry number, fax number and the like, the facsimile transmission unit 60 transmits the acknowledgement data which consists of the image data obtained by the trace 53 and the request data. Therefore, the fax device 13 receives the acknowledgement data from the facsimile transmission unit 60 through the public line 3. As a result, receiver's reception acknowledgement can be presented to customer in 5 to 15 minutes anywhere in Japan.

Therefore, customer can confirm the receiver's reception acknowledgement in a short time and additionally, the cost of storage space for slips such as the arrival sheets can be reduced. Further, since the fax device 13 receives the data via the public line 3, data security can be secured.

In the case that the portable telephone 12 or the PC 11 is used, since the request window for reception stamp will be displayed, it is easy to find what data customer needs to enter into each item of the request for reception stamp. Consequently, the entry work is facilitated and operating load of the customer will be reduced.

Further, there is determination whether there is delivery completion information from PDT, indicating the parcel delivery is completed or not. Only if the delivery completion information exists, process for reading the arrival sheet is carried out. Consequently, the process can avoid reading the arrival sheet before the parcel delivery is completed, thereby the reliability being improved.

(Second Embodiment)

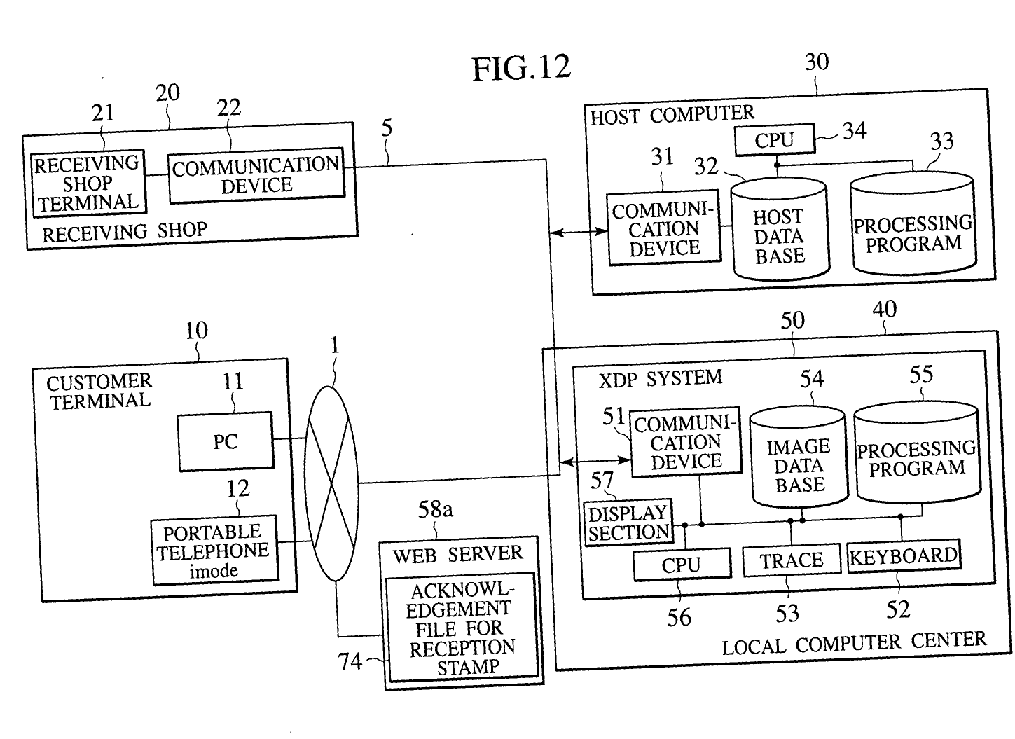

Next, the second embodiment of the delivery reception acknowledging system of the present invention will be described. FIG. 12 is a schematic structure block diagram according to the second embodiment of the present invention. The delivery reception acknowledging system according to the second embodiment has customer terminals 10 each containing the PC 11 and the portable telephone 12, the receiving shops 20, the host computer 30, the local computer centers 40 and the web server 58a connected to the Internet 1.

The feature of the web server 58a is that it has the acknowledgement file 74 for reception stamp and provides the acknowledgement data in the acknowledgement file 74 to the PC 11 or the portable telephone 12, complying with the request for reception stamp from the PC 11 or the portable telephone 12.

In the following description, the same components as those of the delivery reception acknowledging system according to the first embodiment, are designated by like reference numbers.

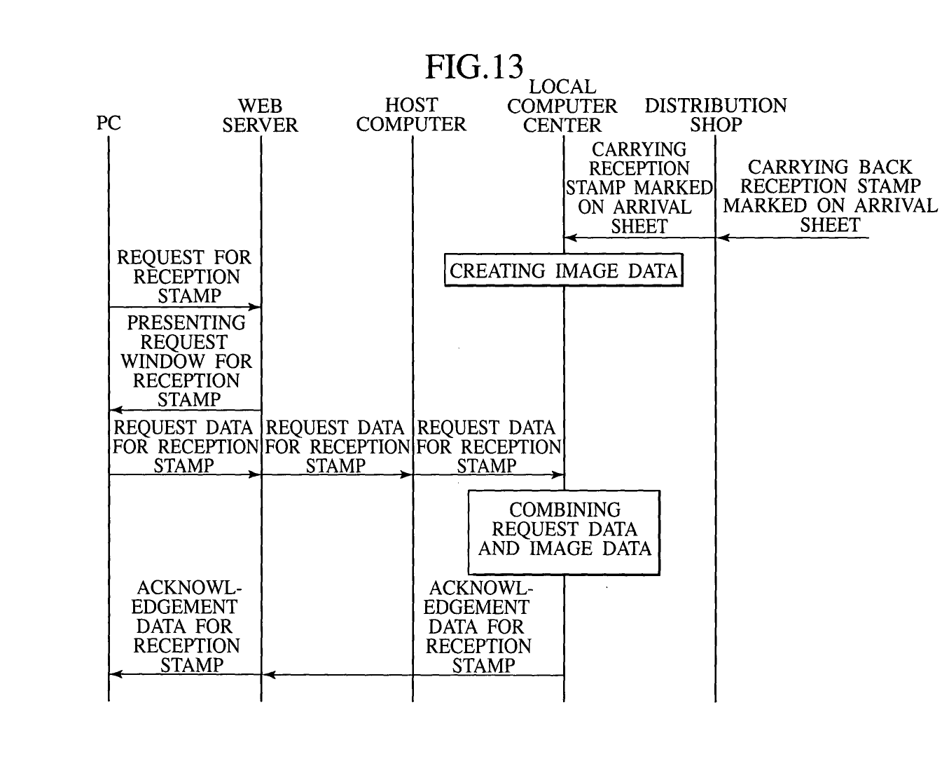

The delivery reception acknowledging method realized by the delivery reception acknowledging system according to the second embodiment will be described with reference to a sequence diagram shown in FIG. 13. Since the process for reading an image of the reception stamp is the same as the process (flow chart of FIG. 7) described at the delivery reception acknowledging system of the first embodiment, description thereof is omitted here.

Next, when URL of a XX express company is inputted through the PC 11, the home page of the XX express company is presented from the web server 58a. Then, the request service for reception stamp in the home page is selected. If each item of the request for reception stamp is entered to according to the request window for reception stamp provided by the web server 58a, the request data for reception stamp entered to the request window is stored in the web server 58a through the Internet 1.

The host computer 30 accesses the web server 58a periodically so as to receive the request data from the web server 58a and creates the request file 73 for reception stamp in the host data base 32.

Next, in the XDP system 50, the CPU 56 determines whether or not there is the same inquiry number as the inquiry number from the PC 11 with reference to the image file 71. If the same inquiry number exists, it retrieves image data corresponding to that inquiry number.

Further, the CPU 56 combines the retrieved image data and the request data from the PC 11 so as to create the acknowledgement file 74 for reception stamp, wherein the acknowledgement file 74 is composed of the acknowledgement data and transmits it to the host computer 30. After the transmission, the communication device 31 transmits the created acknowledgement file 74 to the web server 58a. Since the web server 58a presents the acknowledgement data in the acknowledgement file 74 to the PC 11 in response to the request for the reception stamp from the PC 11, the acknowledgement data as shown in FIG. 11 is displayed on the screen.

Therefore, customer can confirm receiver's reception acknowledgment in a short time and further, the cost of storage space for slips such as the arrival sheets can be reduced.

When the portable telephone 12 or the PC 11 is used, its request window for the reception stamp is displayed. Thus, it is easy to find what data customer needs to enter into each item of the request for reception stamp. Consequently, the entry work is facilitated and operating load of the customer will be reduced.

Furthermore, it is determined whether or not there is delivery completion information from PDT, indicating this delivery is completed. Only if such delivery completion information exists, process for reading the arrival sheet is carried out. Consequently, the process can avoid reading the arrival sheet before the parcel delivery is completed, thereby the reliability being improved.

In the meantime, the present invention is not limited to the delivery reception acknowledging method and the system according to the first and second embodiments. The delivery reception acknowledging system of the present invention can be applied to a case where a parcel is carried from a domestic sender to an overseas receiver or a case where a parcel is transported from an overseas sender to a domestic receiver.

In the delivery reception acknowledging system according to the first and second embodiment, although a delivery person of a distribution shop carries the arrival sheet marked with the reception stamp to the trace 53 in the local computer center 40, it is permissible for the distribution shop to have the trace 53 and transmit image data read by the trace 53 to the local computer center 40 through communication line.

### INDUSTRIAL APPLICABILITY

As described above, according to the delivery reception acknowledging method and the delivery reception acknowledging system of the present invention, an image of reception acknowledgement is obtained by reading a slip to acknowledge a reception and when a reception acknowledgement is requested from a terminal provided on a sender side through communication network, the image of the reception acknowledgement is transmitted to the sender complying with the request for the reception acknowledgement from the terminal through communication network. As a result, customer can confirm a receiver's reception acknowledgement with its security in a short time and additionally, the cost of storage space for slips such as the arrival sheets can be reduced.

Further, according to the delivery reception acknowledging method and the delivery reception acknowledging system of the present invention, an image of reception acknowledgement is obtained by reading a slip to acknowledge a reception and when a reception acknowledgement is requested from a terminal provided on a sender side through communication network, the image of reception acknowledgement is transmitted to a server connected to communication network complying with the request for the reception acknowledgement from the terminal. Therefore, the image of the reception acknowledgement is presented to the terminal from the server through communication network. As a result, customer can confirm a receiver's reception acknowledgement in a short time and additionally, the cost of storage space for slips such as the arrival sheets can be reduced.

1. A delivery reception acknowledging method for receiving a receiver's reception acknowledgement on a slip containing sender information and receiver information when a parcel sent from a sender is delivered to a receiver, the method comprising:
reading the slip on which the reception acknowledgement is marked so as to obtain an image of the reception acknowledgement;
requesting the reception acknowledgement from a terminal provided on the side of the sender through a communication network; and
transmitting the image of the reception acknowledgement to the side of the sender through the communication network complying with a request for the reception acknowledgement from the terminal.

2. A delivery reception acknowledging method for receiving a receiver's reception acknowledgement on a slip containing sender information and receiver information when a parcel sent from a sender is delivered to a receiver, the method comprising:
reading the slip on which the reception acknowledgement is marked so as to obtain an image of the reception acknowledgement;
requesting the reception acknowledgement from a terminal provided on the side of the sender through a communication network;
transmitting the image of the reception acknowledgement to a server connected to the communication network complying with a request for the reception acknowledgement from the terminal; and
presenting the image of the reception acknowledgement from the server to the terminal through the communication network.

3. The delivery reception acknowledging method as in claim 1 or 2, wherein the terminal inputs an inquiry number indicating a slip number of the slip and a transmission destination number indicating a destination to which the image of the reception acknowledgement is transmitted.

4. The delivery reception acknowledging method as in claim 1, wherein a request window for reception acknowledgement for urging entry in each item in response to the request for the reception acknowledgement, the request window being presented to the terminal through the communication network and the terminal inputs at least an inquiry number indicating a slip number of the slip and a transmission destination number indicating a destination to which the image of the reception acknowledgement is transmitted, as each item of the request for the reception acknowledgement according to the request window provided.

5. The delivery reception acknowledging method as in claim 2, wherein the server presents the request window for the reception acknowledgement to the terminal through the communication network, the request window urging entry in each item in response to the request for the reception acknowledgement, and the terminal inputs at least an inquiry number indicating a slip number of the slip and a transmission destination number indicating a destination to which the image of the reception acknowledgement is transmitted, as each item of the request for the reception acknowledgement according to the window provided by the server.

6. The delivery reception acknowledging method as in any one of claims 3 to 5, further comprising:
storing the image of the reception acknowledgement in an image file corresponding to the inquiry number;
retrieving the image of the reception acknowledgement corresponding to the inquiry number from the terminal with reference to the image file; and
transmitting the retrieved image of the reception acknowledgement to a destination indicated by the transmission destination number.

7. The delivery reception acknowledging method as in any one of claims 1 to 6, wherein it is determined whether or not there is delivery completion information indicating that the parcel delivery is completed, the delivery completion information being transmitted from a portable terminal by a delivery person when the parcel delivery is completed.

8. A delivery reception acknowledging system for receiving a receiver's reception acknowledgement on a slip containing sender information and receiver information when a parcel sent from a sender is delivered to a receiver, the system comprising:
a reading means for reading the slip on which the reception acknowledgement is marked so as to obtain an image of the reception acknowledgement;
a terminal for requesting the reception acknowledgement, the terminal provided on the side of the sender and connected to a communication network;
a transmitting means for transmitting the image of the reception acknowledgement obtained by the reading means complying with a request for the reception acknowledgement from the terminal, the transmitting means connected to the communication network; and
a receiving means for receiving the image of the reception acknowledgement from the transmitting means through the communication network, the receiving means provided on the side of the sender.

9. A delivery reception acknowledging system for receiving a receiver's reception acknowledgement on a slip containing sender information and receiver information when a parcel sent from a sender is delivered to a receiver, the system comprising:
a reading means for reading the slip on which the reception acknowledgement is marked so as to obtain an image of the reception acknowledgement;
a terminal for requesting the reception acknowledgement, the terminal provided on the side of the sender and connected to communication network;
a transmitting means for transmitting the image of the reception acknowledgement obtained by the reading means complying with a request for the reception acknowledgement from the terminal; and
a server for presenting the image of the reception acknowledgement from the transmitting means to the terminal, the server connected to the communication network.

10. The delivery reception acknowledging system as in claim 8 or 9, wherein the terminal inputs an inquiry number indicating a slip number of the slip and a transmission destination number indicating a destination to which the image of the reception acknowledgement is transmitted.

11. The delivery reception acknowledging system as in claim 8, further comprising:
a server for presenting a request window for the reception acknowledgement to the terminal through the communication network, the request window urging entry in each item in response to the request for the reception acknowledgement,
wherein the terminal inputs at least an inquiry number indicating a slip number of the slip and a transmission destination number indicating a destination to which the image of the reception acknowledgement is transmitted, as each item of the request window for the reception acknowledgement according to the window presented by the server.

12. The delivery reception acknowledging system as in claim 9, wherein the server presents the request window for the reception acknowledgement to the terminal through the communication network, the request window urging entry in each item complying with the request for the reception acknowledgement, and the terminal inputs at least an inquiry number indicating a slip number of the slip and a transmission destination number indicating a destination to which the image of the reception acknowledgement is transmitted as each item for the request according to the window presented by the server.

13. The delivery reception acknowledging system as in claim 10 to 12, further comprising:
an image file for storing the image of the reception acknowledgement obtained by the reading means in correspondence with the inquiry number; and
a retrieving means for retrieving the image of the reception acknowledgement corresponding to the inquiry number from the terminal with reference to the image file,
wherein the transmitting means transmits the image of the reception acknowledgement retrieved by the retrieving means to a destination indicated by the transmission destination number.

14. The delivery reception acknowledging system as in any one of claims 8 to 13, wherein it is determined whether or not there is delivery completion information indicating that the parcel delivery is completed, the delivery completion information being transmitted from a mobile terminal by a delivery person when the parcel delivery is completed.
